(19) United States
(12) Patent Application Publication
(10) Pub. No.: US 2003/0048595 A1
(43) Pub. Date: Mar. 13, 2003

(54) Collapsible keyboard

(75) Inventors: Owen Hsieh, Taipei (TW); Chun-Kuan Lin, Taipei (TW)

Correspondence Address: MORGAN, LEWIS & BOUCKIUS LLP, 1800 M. Street, N.W., Washington, DC, 20036-5869, US

(73) Assignee: Omniwin Corp.

(21) Appl. No.: 10/044,933

(22) Filed: Jan. 15, 2002

(30) Foreign Application Priority Data
Sep. 10, 2001 (TW) 090215522

(51) Int. Cl. G06F 1/16

(52) U.S. Cl. 361/680; 400/482

(57) ABSTRACT

A collapsible keyboard includes a middle subframe, and right and left subframes respectively disposed at and connected to two sides of the middle subframe by two levers, each of which is pivotally mounted on each pair of the adjacent subframes. Thus, the right and left subframes are swingable relative to the middle subframe between a deployed position, where the subframes are aligned with each other in a row, and a collapsed position, where the left and right subframes are superimposed upon and abut against the middle subframe.

### CROSS-REFERENCE TO RELATED APPLICATION

This application claims priority of Taiwan patent Application No. 090215522, filed on Sep. 10, 2001.

### BACKGROUND OF THE INVENTION

1. Field of the Invention

This invention relates to a collapsible keyboard, more particularly to a collapsible keyboard with left and right subframes which are swingable to superimpose upon a middle subframe for facilitating storage and carrying.

2. Description of the Related Art

In an attempt to reduce the size of an electronic equipment, referring to FIGS. 1, 2 and 3, a conventional collapsible keyboard 9, which is used with a PDA, is shown to include four subframes 91, 92, 93, 94 arranged in a row. Each pair of adjacent subframes are pivotally connected together along a folding axis such that the keyboard is foldable about the folding axes. As shown in FIG. 3, the right and left subframes 94,91 can be used as an outer cover to be fastened to each other.

Owing to a thickness of the keyboard, two connecting portions 95 are disposed between the left and middle subframes 91,92 and between the right and middle subframes 94,93, respectively. Thus, when in a deployed position, as shown in FIG. 1, keys 910,940, which are mounted on the left and right subframes 91,94, are movable toward each other. As such, when it is desired to fold the keyboard, it is required to move the keys 910,940 outwardly away from the connecting portions 95, as shown in FIG. 2, so as to permit the subframes 91,92,93,94 to be collapsed. Therefore, the folding and deploying operations are somewhat inconvenient to conduct.

Moreover, a connecting port 96 is disposed on the middle subframe 92 for electrical connection to a PDA (not shown). A support frame 97 is mounted to prop up the PDA. Since the support frame 97 has a dimension much smaller than that of the PDA, the propping force is insufficient to support the PDA steadily.

### SUMMARY OF THE INVENTION

The object of the present invention is to provide a collapsible keyboard which can overcome the problems described above.

According to this invention, the collapsible keyboard includes a left subframe, a right subframe which is disposed opposite to the left subframe in a row direction, and a middle subframe which is disposed between the left and right subframes. Each of the left, right and middle subframes has upper and lower major wall surfaces opposite to each other in a first direction transverse to the row direction. The upper major wall surface of the middle subframe has such a configuration as to permit the lower major wall surfaces of the left and right subframes to be superimposed thereupon. Left, middle, and right area keys are mounted on the upper major wall surfaces of the left, middle and right subframes, respectively. A left lever has two ends which are pivotally and respectively mounted to the left and middle subframes about two left axes that extend in a second direction transverse to the row and first directions. A right lever has two ends which are pivotally and respectively mounted to the right and middle subframes about two right axes that extend in the second direction. As such, each of the left and right subframes is swingable relative to the middle subframe between a deployed position, where the left, middle and right subframes are aligned with each other in the row direction, and a collapsed position, where the lower major wall surfaces of the left and right subframes are disposed to superimpose upon and abut against the middle area keys.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a top schematic view of a conventional collapsible keyboard in a state of use;

FIG. 2 is a top schematic view of the conventional keyboard in a state of folding;

FIG. 3 is a side schematic view of the conventional keyboard when collapsed;

FIG. 4 is a perspective view of a preferred embodiment of a collapsible keyboard according to this invention when collapsed;

FIG. 5 is a side view of the preferred embodiment;

FIG. 6 is a side view of the preferred embodiment showing a cover thereof in a support position;

FIG. 7 is a schematic plan view of right, middle and left subframes of the preferred embodiment in a deployed state;

FIGS. 8, 9 and 10 are side schematic views of the right, middle and left subframes of the preferred embodiment showing how the keyboard is deployed;

FIG. 11 is an exploded perspective view of the preferred embodiment.

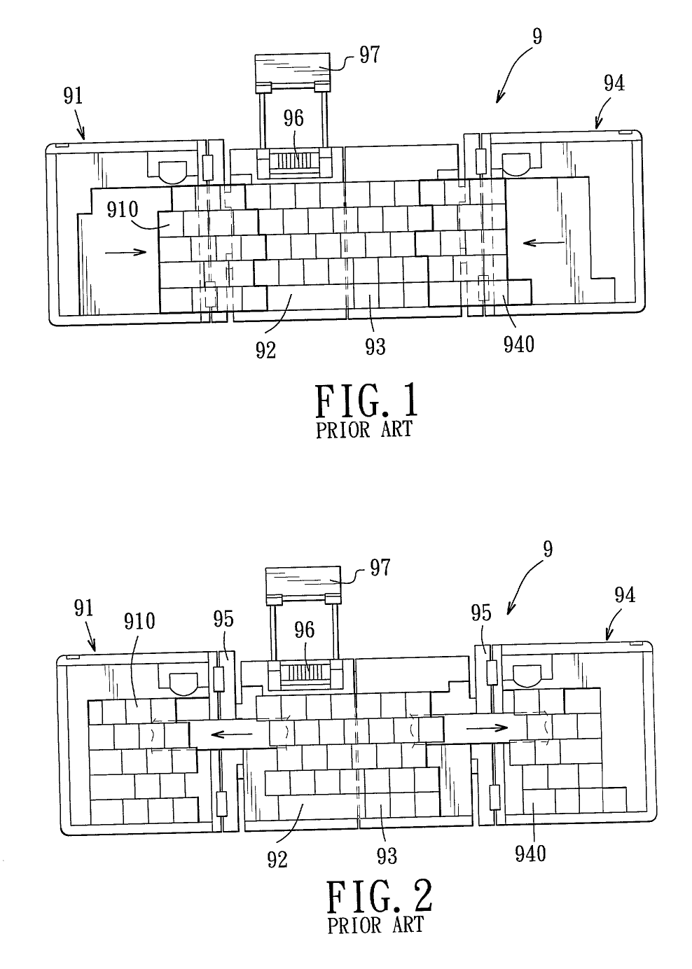

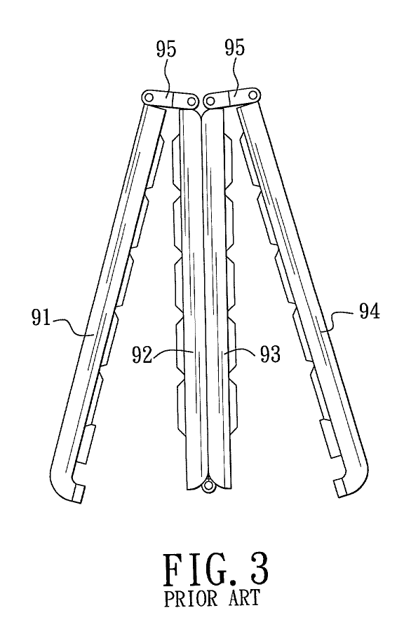

### DETAILED DESCRIPTION OF THE PREFERRED EMBODIMENT

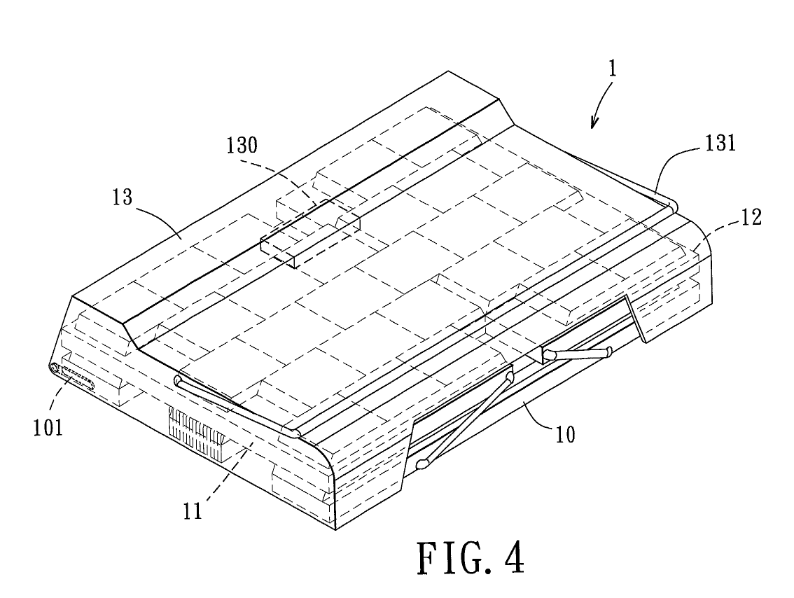

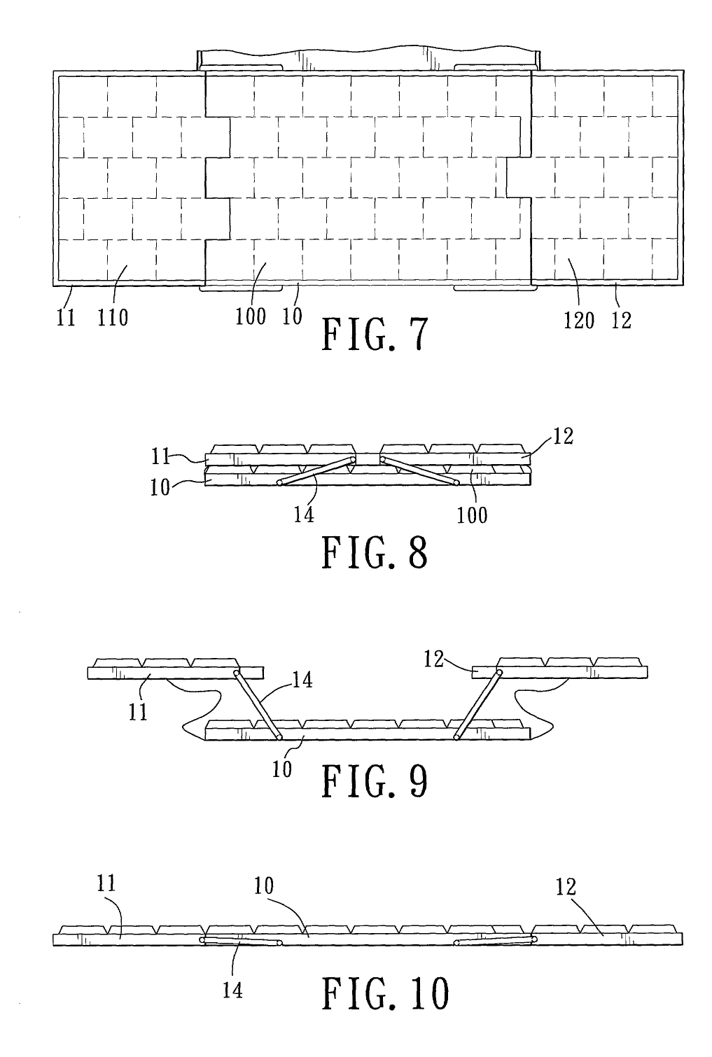

Referring to FIGS. 4, 5 and 7, the preferred embodiment of the collapsible keyboard 1 according to the present invention is shown to comprise a left subframe 11, a right subframe 12 which is disposed opposite to the left subframe 11 in a row direction, and a middle subframe 10 which is disposed between the left and right subframes 11,12. Each of the left, right and middle subframes 11, 12, 10 has upper and lower major wall surfaces opposite to each other in a first direction transverse to the row direction. The upper major wall surface of the middle subframe 10 has a surface area substantially the same as those of the lower major wall surfaces of the left and right subframes 11,12 to permit the lower major wall surfaces of the left and right subframes 11,12 to be superimposed thereupon. Left, middle and right area keys 110, 100, 120 are mounted on the upper wall surfaces of the left, middle and right subframes 11, 10, 12, respectively. Left, middle and right circuit boards (not shown) are mounted in the left, middle and right subframes 11, 10, 12 under the left, middle and right area keys 110, 100, 120.

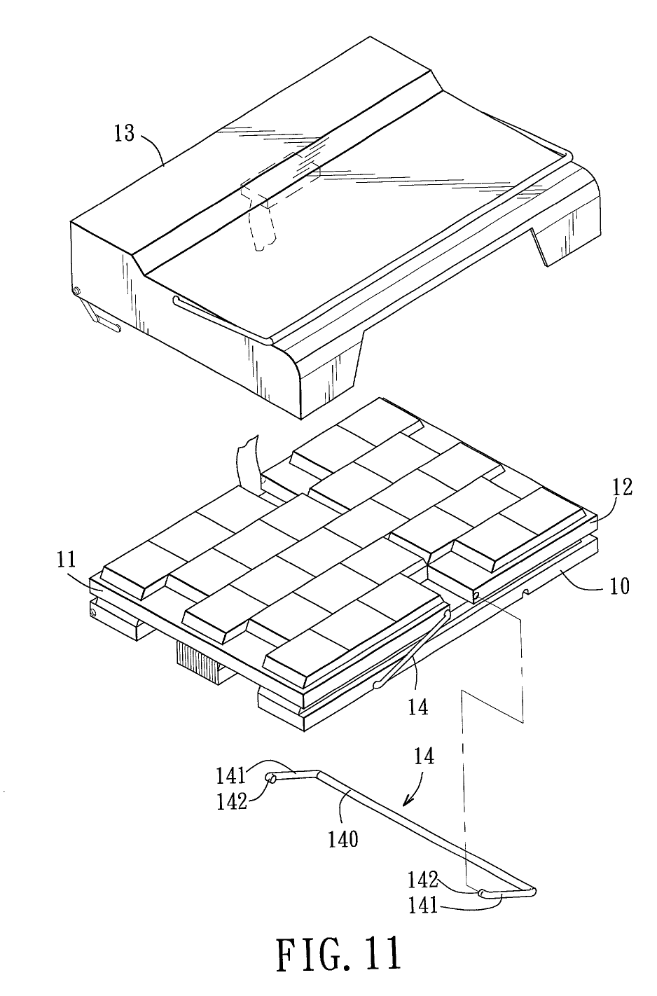

With reference to FIGS. 8 to 11, right and left levers 14, such as connecting rods, are disposed to interconnect the right and middle subframes 12,10, and the left and middle subframes 11,10, respectively. Each of the right and left levers 14 includes an intermediate rod portion 140 with two ends, and two arm portions 141 which extend from the ends to terminate at positioning ends 142 that are to be inserted rotatably into and to be retained in the respective right, middle and left subframe 12, 10, 11. As such, the arm portions 141 of the right lever 14 are pivotally mounted to the right and middle subframes 12, 10 about two right axes which extend in a second direction transverse to the row and first directions. The arm portions 141 of the left lever 14 are pivotally mounted to the left and middle subframes 11,10 about two left axes which extend in the second direction. Thus, each of the left and right subframes 11,12 is swingable relative to the middle subframe 10 between a deployed position, as shown in FIG. 10, where the left, middle and right subframes 11, 10, 12 are aligned with each other in the row direction, and a collapsed position, as shown in FIG. 8, where the lower major wall surfaces of the left and right subframes 11,12 are disposed to superimpose upon and abut against the middle area keys 100.

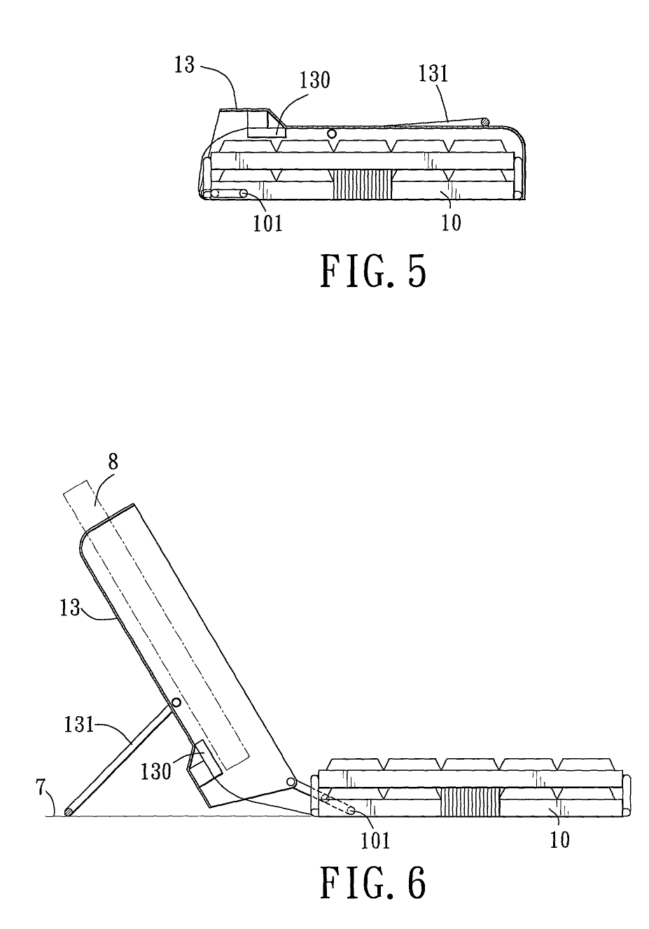

Moreover, as shown in FIGS. 4 and 5, a cover 13 is hinged on the middle subframe 10 about a hinged axis 101 in the row direction so as to cover the subframes 11, 10, 12 when the right and left subframes 12,11 are disposed in the collapsed position. Preferably, as shown in FIG. 6, a support post 131 is pivotally mounted on an outer major surface of the cover 13, and is rotatable between a support position to be adapted to support and to hold the cover 13 angularly relative to a desk surface 7, and a folded position proximate to the cover 13. Further, a connecting port 130 is mounted on the cover 13 adjacent to the hinged axis 101 and is electrically connected to the circuit boards. As such, when the keyboard 1 is used with a PDA 8, the PDA 8 can be placed on an inner major surface of the cover 13 while the support post 131 is in the support position, and is electrically connected to the connecting port 130. Once it is desired to store and carry the keyboard 1, the right and left subframes 12,11 are swung to the collapsed position, and the cover 13 is rotated to cover the subframes 11, 10, 12 while the support post 131 is rotated to the folded position. Therefore, the deploying and collapsing operations are convenient to conduct. In addition, the PDA 8 is connected steadily to the keyboard 1.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

We claim:

1. A collapsible keyboard comprising:
a left subframe, a right subframe disposed opposite to said left subframe in a row direction, and a middle subframe disposed between said left and right subframes, each of said left, right and middle subframes having upper and lower major wall surfaces opposite to each other in a first direction transverse to the row direction, said upper major wall surface of said middle subframe being of such a configuration as to permit said lower major wall surfaces of said left and right subframes to be superimposed thereupon;
left, middle, and right area keys mounted on said upper major wall surfaces of said left, middle and right subframes, respectively;
a left lever having two ends pivotally and respectively mounted to said left and middle subframes about two left axes which extend in a second direction transverse to the row and first directions; and
a right lever having two ends pivotally and respectively mounted to said right and middle subframes about two right axes which extend in the second direction;
each of said left and right subframes being swingable relative to said middle subframe between a deployed position, where said left, middle and right subframes are aligned with each other in the row direction, and a collapsed position, where said lower major wall surfaces of said left and right subframes are disposed to superimpose upon and abut against said middle area keys.

2. The collapsible keyboard of claim 1, wherein each of said right and left lever is a connecting rod including an intermediate rod portion formed with said two ends, and two arm portions, each extending from a respective one of said two ends along a respective one of said right and left axes to terminate at a positioning end that is to be inserted rotatably into and to be retained in a respective one of said right, left and middle subframes.

3. The collapsible keyboard of claim 1, further comprising a cover hinged on said middle subframe about a hinged axis in the row direction and of such a dimension as to cover said right and left subframes when said right and left subframes are disposed in the collapsed position.

4. The collapsible keyboard of claim 3, further comprising a support post pivotally mounted on said cover and rotatable between a support position to be adapted to support and to hold said cover angularly relative to a flat surface, and a folded position proximate to said cover.

5. The collapsible keyboard of claim 4, wherein said cover has an outer major surface, and an inner major surface opposite to said outer major surface and proximate to said middle area keys, said keyboard further comprising a circuit assembly mounted between said upper major wall surfaces and said right, middle and left area keys, and a connecting port mounted on said cover adjacent to the hinged axis and electrically connected to said circuit assembly such that when said inner major surface is adapted to prop up a display screen panel in the support position, said connecting port is adapted to be electrically connected to said display screen panel.
